(19) United States
(12) Patent Application Publication
(10) Pub. No.: US 2025/0268778 A1
(43) Pub. Date: Aug. 28, 2025

(54) Walking Assistance Apparatus

(71) Applicant: James Jacono, Claymont, DE (US)

(72) Inventor: James Jacono, Claymont, DE (US)

(21) Appl. No.: 19/066,489

(22) Filed: Feb. 28, 2025

Related U.S. Application Data
(60) Provisional application No. 63/558,769, filed on Feb. 28, 2024.

(51) Int. Cl. A61H 3/04

(52) U.S. Cl. CPC A61H 3/04; A61H 2201/1635

(57) ABSTRACT

The walking assistance apparatus includes an elongated top bar having at each end of the elongated top bar a pair of vertical passageways extending through the elongated top bar. The walking assistance apparatus further includes a pair of fastener attachments positioned on each handle of an existing walker. The walking assistance apparatus further includes a pair of columns, each column is coupled to each fastener attachment, each column includes a post extending through a channel of the column and each vertical passageway of the elongated top bar. The walking assistance apparatus further includes a pair of release handles, each release handle couples to the post.

### CROSS-REFERENCE TO RELATED APPLICATION

This application claims the benefit of U.S. Provisional Patent Application No. 63/558,769 filed on Feb. 28, 2024.

### FIELD OF THE INVENTION

The present invention relates to a walking assistance apparatus and, more particularly, to a walking assistance apparatus for stabilizing a user and relieving neck pressure of a user while utilizing a common walker.

### BACKGROUND

In general, various types of devices have been employed to assist people who are recovering from various types of injuries and surgeries, or who are experiencing weakness or instability from conditions associated with advanced age or other causes, in moving. Various types of four-legged walkers have been designed. However, the various types of walkers that have been designed, fail to provide the necessary stability based on the current elevation and handle placement on the walker. Additionally, the various types of walkers that have been designed fail to relieve pressure in a user's neck which equates in some user's numbness of the hands and shortness of breath.

Accordingly, a need remains for providing the user with proper stability and relief of neck pressure while utilizing a walker. As the foregoing illustrates, the invention provides a walking assistance apparatus.

### SUMMARY

The walking assistance apparatus includes an elongated top bar having at each end of the elongated top bar a pair of vertical passageways extending through the elongated top bar. The walking assistance apparatus further includes a pair of fastener attachments positioned on each handle of an existing walker. The walking assistance apparatus further includes a pair of columns, each column is coupled to each fastener attachment, each column includes a post extending through a channel of the column and each vertical passageway of the elongated top bar. The walking assistance apparatus further includes a pair of release handles, each release handle couples to the post.

### BRIEF DESCRIPTION OF DRAWINGS

In the following, the present invention is described in more detail with references to the drawings in which:

FIG. 1 illustrates a perspective view of the invention positioned on a walker;

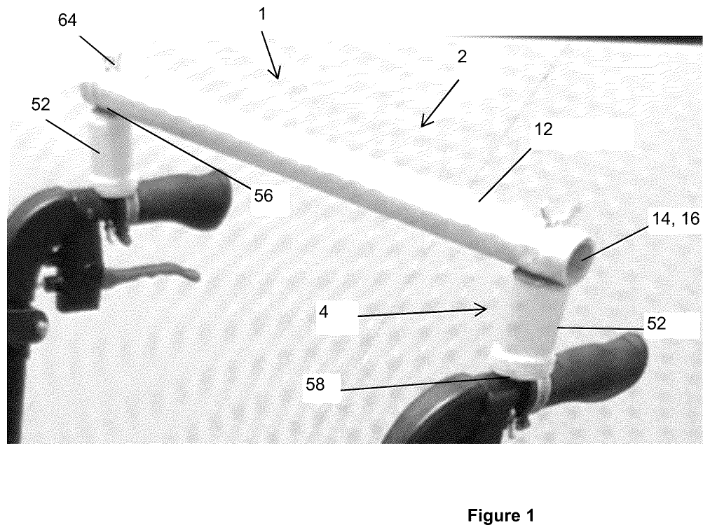

FIG. 2 illustrates a top view of an quick release handle of the invention;

FIG. 3 illustrates a right side view of the quick release handle of FIG. 2;

FIG. 4 illustrates another right side view of the quick release handle of FIG. 3;

FIG. 5 illustrates a perspective view of a fastener assembly and a clamp fastener;

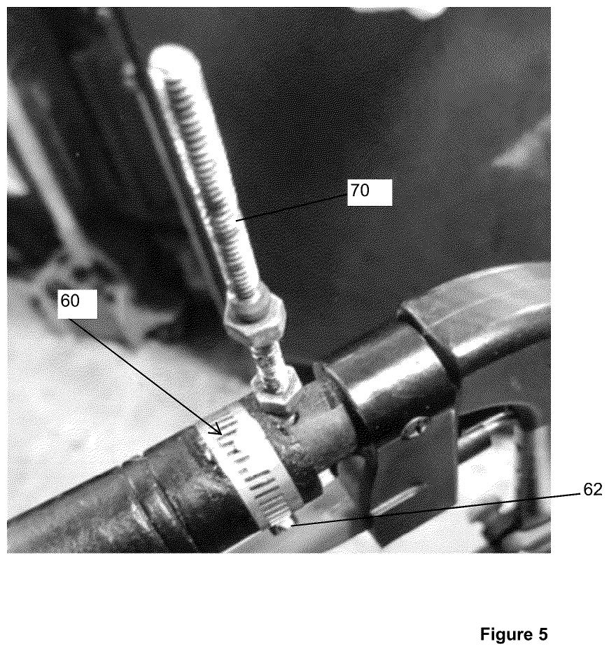

FIG. 6 illustrates another perspective view of the fastener assembly and the clamp fastener;

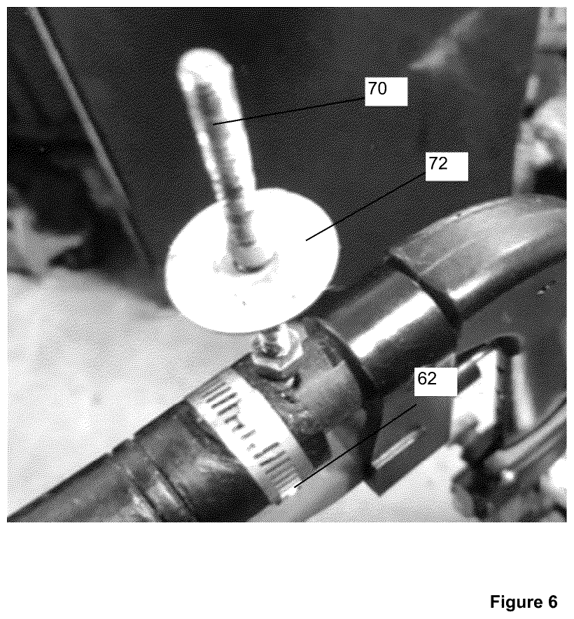

FIG. 7 an exploded view of the invention;

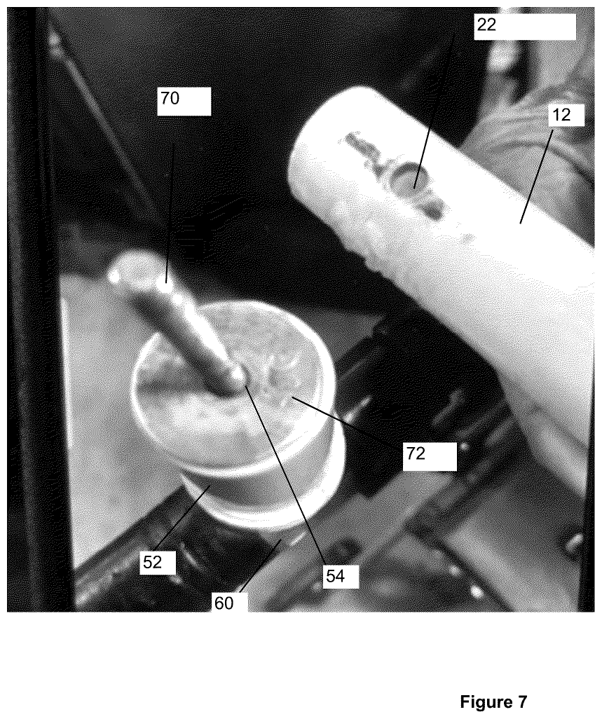

FIG. 8 illustrates a top perspective view of the invention;

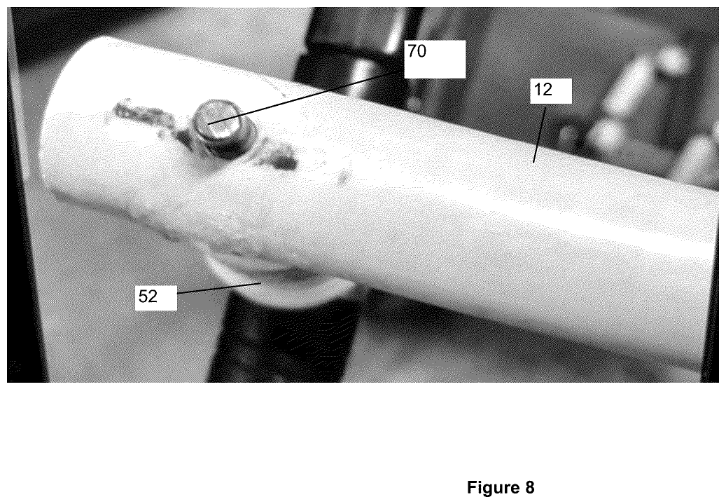

FIG. 9 illustrates another top perspective view of the invention;

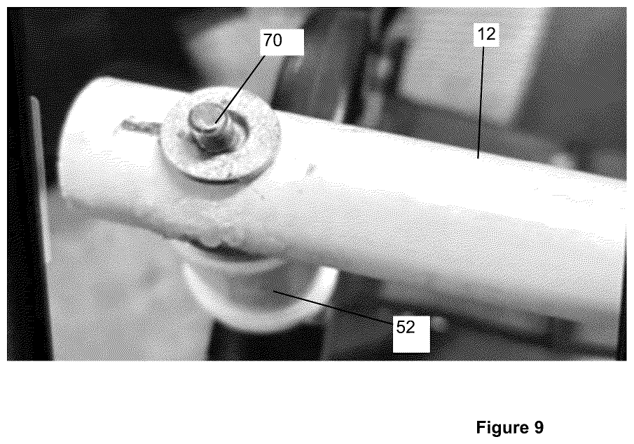

FIG. 10 illustrates a top, front, left side perspective view of the invention;

FIG. 11 illustrates another perspective view of the invention of FIG. 10;

FIG. 12 illustrates another perspective view of the invention;

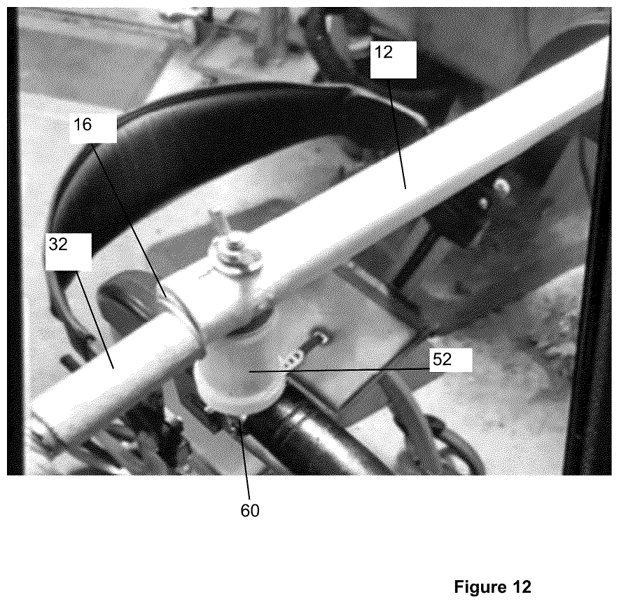

FIG. 13 illustrates another perspective view of the invention; and

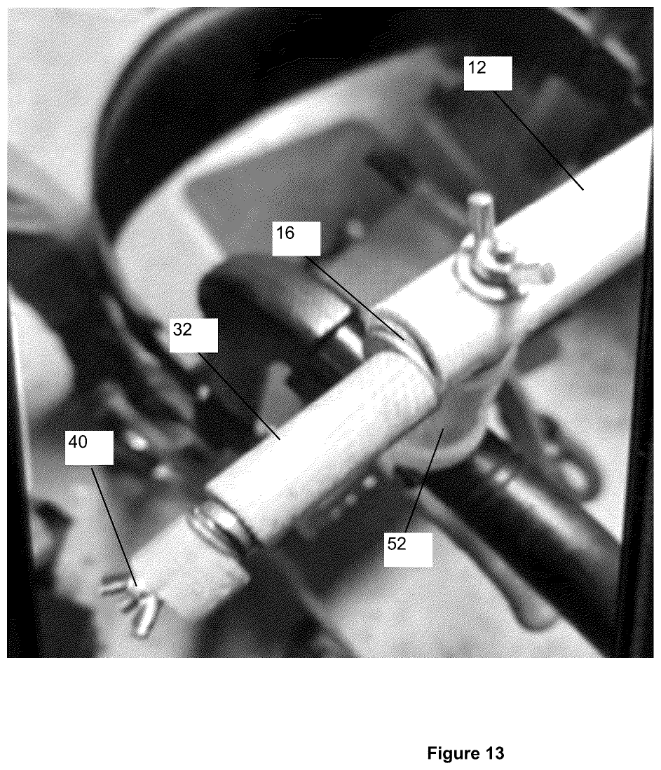

FIG. 14 illustrates a perspective view of the walking assistance apparatus 1 attached to a mobile vehicle.

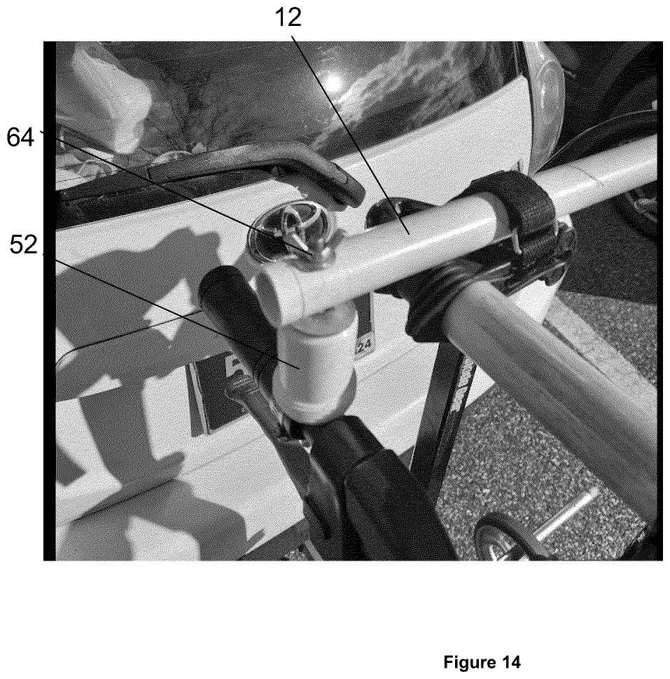

### DETAILED DESCRIPTION OF THE EMBODIMENT(S)

The present disclosure includes a walking assistance apparatus 1 according to the invention. In the exemplary embodiment, the walking assistance apparatus 1 generally includes an upper portion 2 and a lower portion 4.

In an exemplary embodiment, with reference to the figures, the upper portion 2 includes a top bar 12. The top bar 12 is an elongated cylindrical member. However, one skilled in the art will appreciate that the shape of the top bar 12 is not the exclusive shape. The top bar 12 further includes a passageway 14 extending a length of the top bar 12. One skilled in the art would understand the applicant's design is not the exclusive embodiment.

In the exemplary embodiment, the top bar 12 further includes an inner beam 16. The inner beam 16 is a cylindrical member which extends at least half the length of the top bar 12. One skilled in the art would understand the applicant's design is not the exclusive embodiment.

In the exemplary embodiment, the top bar 12 further includes a plurality of passageways 22. The at least four passageways 22 are positioned and extend through the top bar 12 in a vertical direction with respect to the top bar 12. At least two passageways 22 are parallel, which form a continuous passageway through the top bar 12.

In the exemplary embodiment, the inner beam 16 is positioned between the plurality of passageways 22 of the top bar 12.

In the exemplary embodiment, the upper portion 2 further includes an extension mechanism 30. The extension mechanism 30 includes a pair of quick release handles 32, an adjustment cover 36 and a fastener assembly 40.

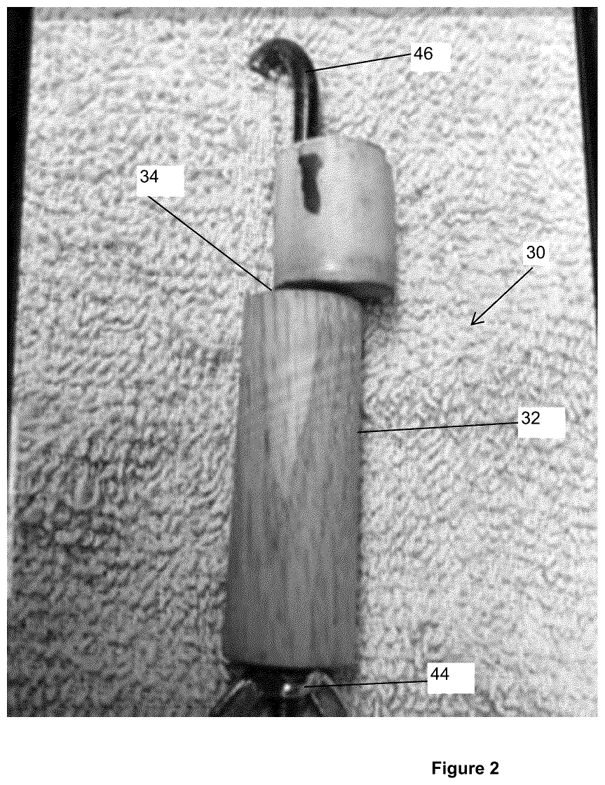

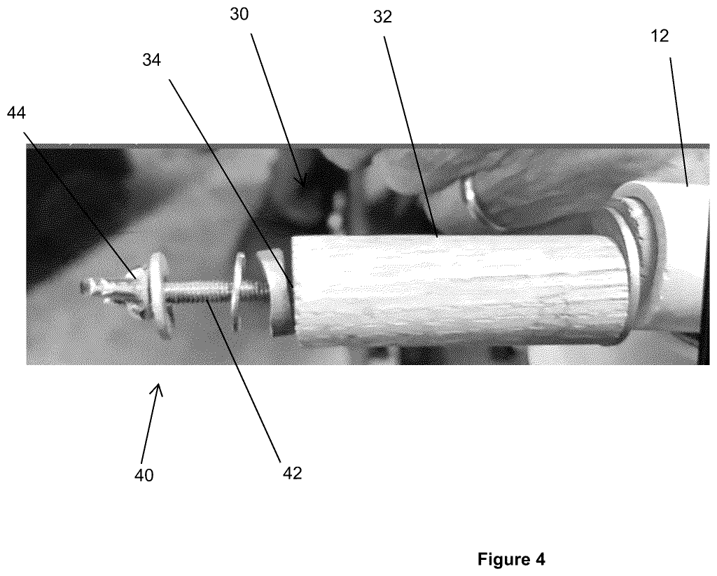

As shown in FIG. 2, each quick release handle 32 is a cylindrical member. One skilled in the art would understand the applicant's design is not the exclusive embodiment. In another embodiment and as shown in FIG. 4, each quick release handle 32 is a two piece cylindrical member.

In the exemplary embodiment, the quick release handle 32 further includes a passageway 34 extending through a length of the quick release handle 32.

In the exemplary embodiment, the adjustment cover 36 is semi cylindrical in shape and positioned between the quick release handle 32 and a fastener 44 of the fastener assembly 40.

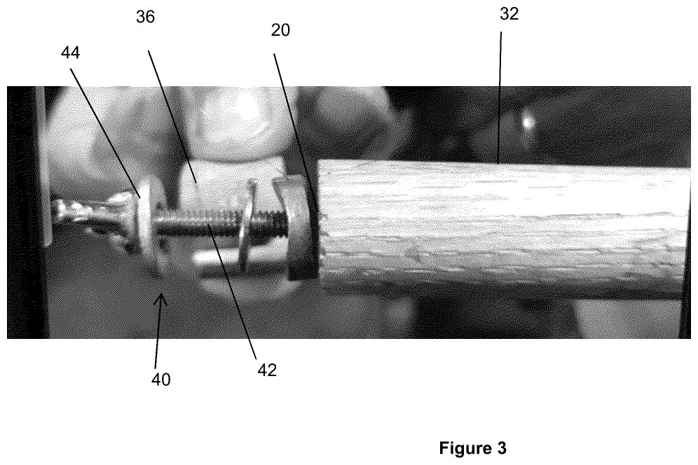

As shown in FIG. 3, the fastener assembly 40 includes a threaded rod 42 and a fastener 44. One skilled in the art would understand the applicant's design is not the exclusive embodiment. The threaded rod 42 further includes a curvature member 46, specifically, the curvature member 46 is hook shaped. One skilled in the art would understand the applicant's design is not the exclusive embodiment.

In an exemplary embodiment and reference to the figures, the lower portion 4 includes a pair of columns 52. Each column 52 is a cylindrical member. However, one skilled in the art will understand the shape of the column 52 is not the exclusive embodiment.

In the exemplary embodiment, each of the at least two columns 52 includes a channel 54. The channel 54 is circular in shape and directed through both a first end 56 and a second end 58 of the column 52.

In another exemplary embodiment, the channel 54 is threaded.

In the exemplary embodiment, the lower portion 4 further includes a fastener attachment 60. The fastener attachment 60 is a standard hook or clasp. In the exemplary embodiment, the fastener attachment 60 is positioned around the handle of the existing walker to restrict movement of the existing walker's handles.

In another embodiment, the fastener attachment 60 is coupled to an end of each column 52. Specifically, the second end 58 of the column. One skilled in the art would understand the applicant's design is not the exclusive embodiment.

In the exemplary embodiment, with reference to the figures, the lower portion 4 further includes a fastener 62. In the exemplary embodiment, the fastener 62 is a standard clamp fastener. One skilled in the art would appreciate other types of fasteners may be utilized. The fastener 62 is coupled to the fastener attachment 60.

In the exemplary embodiment, the lower portion 4 further includes a column coupler 64. The column coupler 64 is a fastener. One skilled in the art would understand the applicant's design is not the exclusive embodiment. In another embodiment, the column coupler 64 can be an end cap covering the passageway 22.

In another exemplary embodiment, the securing post 70 is a threaded rod. One skilled in the art would understand the applicant's design is not the exclusive embodiment.

In another exemplary embodiment, the securing post 70 further includes a securing plate 72. The securing plate 72 is a circular member. One skilled in the art would understand the applicant's design is not the exclusive embodiment.

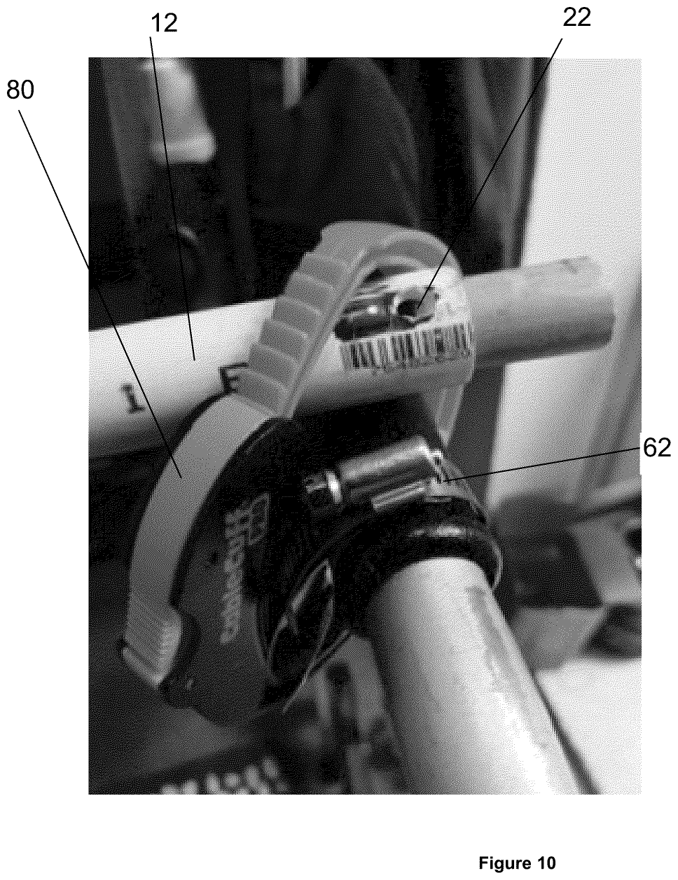

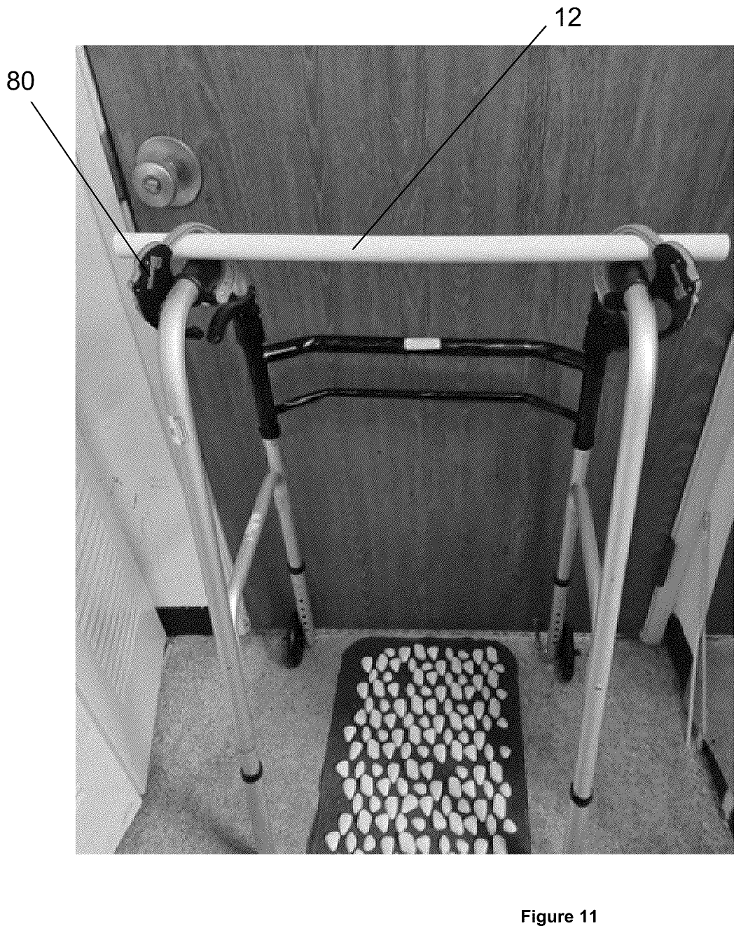

In another exemplary embodiment as shown in FIGS. 10 and 11, the walking assistance apparatus 1 further includes a fastener 80. The fastener 80 can embody any form of fastener or clamp. One skilled in the art would understand the applicant's design is not the exclusive embodiment.

As assembled, in the exemplary embodiment the top bar 12 is positioned horizontally with respect to a level floor or ground. Each column 52 is positioned at an end of the top bar 12. Each of the at least two columns 52 are arranged perpendicular to the top bar 12, where the first end 56 of the column 52 is positioned under the top bar 12. The plurality of passageways 22 are aligned with the channel 54 of the column 52.

In the exemplary embodiment, the at least two passageways 22 of the top bar 12 align with the at least one channel 54 of the column 52. In the exemplary embodiment, the fastener 62 tightens the fastener attachment 60 which is coupled to the existing handle of the existing walker.

In the exemplary embodiment, the securing post 70 is threaded through both a known handle of a known walker and through the first channel 54 of the column 52. The securing post 70 is threaded through the securing plate 72 and then through the passageways 22 of the top bar 12. Thereby, attaching/detaching the upper portion 2 and lower portion 4 to the known walker.

In another exemplary embodiment, the fastener 62 tightens the fastener attachment 60 which is coupled to the second end 58 of the column 52. The columns 52 are then attachable/detachable to a handle of a known walker. The top bar 12 is positioned on top of each column 52 and secured by a fastener (not shown).

In another exemplary embodiment, the fastener 62 tightens the fastener attachment 60 which is coupled to the existing handle of the existing walker. The top bar 12 is positioned horizontally across the existing handles of the existing walker. The fastener 80 is positioned around both the top bar 12 and the existing handle preventing any movement.

In the exemplary embodiment, the quick release handle 32 is positioned abutting the top bar 12 and a curvature member 46 of the threaded rod 42 which couples to the securing post 70. The threaded rod 42 is positioned through the passageway 34 of the quick release handle 32 and into the passageway 14 of the top bar 12. The curvature member 46 of the threaded rod 42 couples to the securing post 70. The adjustment cover 36 is positioned over the exposed portion of the threaded rod 42. The fastener 44 is then threaded to the threaded rod 42 and tightened.

When a user is in need of additional stabilization while walking, the walking assistance apparatus 1 is utilized. The user will select a walker.

In the exemplary embodiment, the user will thread the securing post 70 through an existing pair of walker handles and position the walking assistance apparatus 1 above a pair of handles of the walker. Specifically, securing post 70 will be positioned through the second end 58 of each column 52 and into the channel 54. Additionally, the securing post 70 is positioned through the plurality of passageways 22 of the top bar 12. When the user needs to transport the existing walker with the walking assistance apparatus 1, the user will include the column coupler 64 to secure the walking assistance apparatus 1. Additionally, the user will release the fastener 44 thereby allowing the user to release the curvature member 46 from the securing post 70 and remove the quick release handle 32 from the top bar 12 prior to transporting.

In another exemplary embodiment, the second end 58 of each of the columns 52 will be positioned on and perpendicular to the handles of the known walker. The user will then secure the walking assistance apparatus 1 to the handles by utilizing the fastener 62 of the fastener attachment 60 when circumstances need the user to generate walking in a quicker fashion.

In another exemplary embodiment, the user will position the top bar 12 over a pair of existing handles. The user will then utilize the pair of fasteners 80 to secure the top bar 12 directly to the existing walker.

It should be noted that various changes and modifications to the embodiments described herein will be apparent to those skilled in the art. Such changes and modifications may be made without departing from the spirit and scope of the present invention and without diminishing its intended advantages. For example, various embodiments of the systems and methods may be provided based on various combinations of the features and functions from the subject matter provided herein.

What is claimed is:

1. A walking assistance apparatus, comprises:
an elongated top bar having at each end of the elongated top bar a pair of vertical passageways extending through the elongated top bar;
a pair of fastener attachments positioned on each handle of an existing walker;
a pair of columns, each column is coupled to each fastener attachment, each column includes a post extending through a channel of the column and each vertical passageway of the elongated top bar; and
a pair of release handles, each release handle couples to the post.

2. The walking assistance apparatus of claim 1, wherein each release handle is a cylindrical member.

3. The walking assistance apparatus of claim 2, wherein a passageway extends through the release handle.

4. The walking assistance apparatus of claim 3, wherein the release handle further includes a rod extending through the cylindrical member.

5. The walking assistance apparatus of claim 4, wherein the rod includes a curvature member at a first end of the rod.

6. The walking assistance apparatus of claim 5, wherein the release handle further includes a cover.

7. The walking assistance apparatus of claim 6, wherein the cover is a semi cylindrical member positioned on an exposed portion of the rod.

8. The walking assistance apparatus of claim 7, wherein the release handle further includes a fastener coupled to a second end of the rod.

9. The walking assistance apparatus of claim 8, wherein the walking assistance apparatus further comprises a column coupler positioned on the post and abutting the elongated top bar.

10. The walking assistance apparatus of claim 1, wherein the post is threaded through the handle of the existing walker.

11. The walking assistance apparatus of claim 9, wherein each release handle abuts the elongated top bar.

12. The walking assistance apparatus of claim 11, wherein the curvature member couples to the post.

13. A release handle, comprises:
a cylindrical member having a passageway extending through the cylindrical member;
a threaded rod positioned through the passageway of the cylindrical member, the threaded rod having a first end and a second end, the first end of the threaded rod is hooked shaped; and
a cover positioned over an exposed portion of the threaded rod, abutting the cylindrical member.

14. The release handle of claim 13, wherein the release handle further includes a fastener.

15. The release handle of claim 14, wherein the fastener is positioned on the second end of the threaded rod, abutting the cover.

16. The release handle of claim 15, wherein the cover is semi cylindrical in shape.
